(19) United States
(12) Patent Application Publication
(10) Pub. No.: US 2023/0392062 A1
(43) Pub. Date: Dec. 7, 2023

(54) SUSTAINABLE EVAPORATIVE COOLING COATING FOR A BROAD RANGE OF RELATIVE HUMIDITY

(71) Applicant: The Hong Kong University of Science and Technology, Hong Kong (CN)

(72) Inventors: Yanguang ZHOU, Hong Kong (CN); Guang WANG, Hong Kong (CN)

(21) Appl. No.: 18/322,242

(22) Filed: May 23, 2023

Related U.S. Application Data
(60) Provisional application No. 63/348,008, filed on Jun. 1, 2022.

(51) Int. Cl. C09K 5/04; B01J 20/04; B01J 20/18; B01J 20/30

(52) U.S. Cl. CPC C09K 5/047; B01J 20/046; B01J 20/183; B01J 20/3042; B01J 20/3078

(57) ABSTRACT

A method and a composite for evaporative cooling are provided. The method includes synthesizing MOF-801 and preparing CaCl₂@MOF-801 composite based on the MOF-801. The synthesizing MOF-801 includes dissolving fumaric acid and ZrOCl₂·8H₂O into a solvent having N, N-Dimethylformamide and formic acid to produce a mixture; heating the mixture at a predetermined temperature for a predetermined amount of time; cooling the mixture to room temperature to obtain precipitate of MOF-801; separating the MOF-801 by a filter of a predetermined pore size; and drying the separated MOF-801 at a predetermined temperature for a predetermined amount of time to activate the MOF-801. The preparing CaCl₂@MOF-801 composite includes dissolving a predetermined amount of CaCl₂ in deionized (DI) water; applying ultrasonication to the solution for a predetermined amount of time; and mixing the MOF-801 synthesized with the CaCl₂ solution under ultrasonication at a predetermined temperature for a predetermined amount of time.

### CROSS-REFERENCE TO RELATED APPLICATION

This application claims the benefit of U.S. Provisional Application Ser. No. 63/348,008, filed Jun. 1, 2022, which is hereby incorporated by reference in its entirety including any tables, figures, or drawings.

### BACKGROUND OF THE INVENTION

Cooling is a critical demand not only for buildings (1, 2) to maintain human thermal comfort but also for a wide range of industrial equipment such as data centers (3, 4), solar cell panels (5, 6), and many other areas (7, 8) to sustain high efficiencies. In the United States, heating and cooling account for around 20% of total energy demand and more than $215 billion for annual national energy costs (9). For instance, in 2020 alone, data centers in the United States consumed 73 TWh of electricity and 660 billion liters of water to satisfy the cooling demands (10), which is more than the residential needs of Hong Kong in 2020 (11).

In general, cooling is more challenging than heating according to the second law of thermodynamics (12). While conventional cooling technologies such as refrigeration-based air conditioning systems are powerful in dissipating the heat from buildings, electronics, or vehicles, the huge electricity consumption (13, 14), high expenses (15), and the greenhouse gases generation (7, 16) may discourage people from using these cooling technologies. Further, the power systems of the conventional cooling technologies are mainly supplied by fossil fuel-based thermal power plants, which is deemed as the culprit for carbon emissions. Consequently, it is desirable to develop high-efficiency, environmentally friendly, and sustainable cooling strategies for improving the working efficiency of buildings, data centers and photovoltaics, reducing the carbon emissions, and meeting the ever-increasing energy demands (15, 17, 18).

Evaporative cooling based on the liquid-vapor phase change of water (19, 20) is a promising alternative for air conditioners owing to its super high enthalpy of about 2450 J/g and it is a common practice worldwide to cool the high-temperature roads by spraying water on top (21, 22). Water is also widely used as a coolant in steel industries and nuclear plants (23). Although evaporative cooling is considered an inexpensive, environmentally friendly, and effective approach, the requirement for a large amount of cooling water strongly limits its applications.

Inspired by the breathing process, evaporative cooling via the adsorption-desorption or “breathing” process of atmospheric water (24-26) has been proposed. Atmospheric water is a resource equivalent to about 10% of all freshwater on the Earth, which equals to around 13 thousand trillion liters (27). Therefore, the evaporative cooling via the “breathing” process of atmospheric water in desiccants shows great potentials for solving the cooling problems described above.

One of the critical factors in the evaporative cooling technology is selection of the desiccant used in the “breathing” process. Conventional desiccants such as silica gel, zeolite, and activated alumina generally have a wide atmospheric water adsorption window. Nevertheless, high temperatures are needed for the water desorption process, making the desiccants less preferable atmospheric water adsorbers (28, 29). Most recently, certain metal-organic frameworks (MOFs) such as MOF-801, MOF-303, and MOF-804 have been demonstrated to be ideal “breathing” materials due to their water sorption abilities at low relative humidity (RH) (for example, 0.25 g/g water for MOF-801 at RH of 20% and at 25° C.), thermal stability, high specific surface areas and high mechanical strength (30, 31). However, the relatively low water sorption of these MOFs restricts their cooling power to low levels. On the other hand, hygroscopic salt desiccants such as calcium chloride (CaCl₂) have exhibited high adsorption ability for atmospheric water (32, 33). However, when saturated with the adsorbed atmospheric water, the hygroscopic salt desiccants are dissolved to form aqueous solutions, causing operation and engineering problems of the atmospheric water adsorbers (34-36). Thus, it is desirable to develop a new cooling material combining the advantages of hygroscopic salts with these of the MOFs to achieve high cooling powers and improved operation of the “breathing” processes.

Recent progress in passive evaporative cooling technologies utilizing atmospheric water has substantially enhanced the cooling performance under relative humidity (RH) higher than 60%. Yet, experimental demonstrations of wide-RH passive evaporative cooling using atmospheric water still severely underperform due to the poor atmospheric water adsorption capacity of the traditional sorbents at low RH.

### BRIEF SUMMARY OF THE INVENTION

There continues to be a need in the art for improved designs and techniques for a method for producing an effective evaporative cooling coating.

According to an embodiment of the subject invention, a method of producing an evaporative cooling composite is provided. The method comprises synthesizing MOF-801; and preparing CaCl₂@MOF-801 composite based on the MOF-801. The synthesizing MOF-801 comprises dissolving a predetermined amount of fumaric acid and a predetermined amount of ZrOCl₂·8H₂O into a solvent having a predetermined amount of N, N-Dimethylformamide and a predetermined amount of formic acid to produce a mixture; heating the mixture at a predetermined temperature for a predetermined amount of time; cooling the mixture to room temperature to obtain precipitate of MOF-801; separating the MOF-801 by a filter of a predetermined pore size; and drying the separated MOF-801 at a predetermined temperature for a predetermined amount of time to activate the MOF-801. The preparing CaCl₂@MOF-801 composite comprises dissolving a predetermined amount of CaCl₂ in deionized (DI) water; applying ultrasonication to the solution for a predetermined amount of time; and mixing the MOF-801 synthesized with the CaCl₂ solution under ultrasonication at a predetermined temperature for a predetermined amount of time. Moreover, the CaCl₂@MOF-801 composite is configured to have a ratio of m_{MOF-801}:V_{CaCl}_{₂}=0.7 g/ml such that the CaCl₂@MOF-801 composite is inhibited from being aqueous when water or moisture adsorbed by the CaCl₂@MOF-801 composite is saturated. The fumaric acid and the ZrOCl₂·8H₂O have an equal mole amount. The heating the mixture is performed at a temperature of about 130° C. for about 6 hours. In addition, the filter has a pore size of about 0.45 μm. The drying the separated MOF-801 is performed at a temperature of about 150° C. in a vacuum condition for about 24 hours. Further, the mixing the MOF-801 synthesized with the CaCl₂ solution under ultrasonication is performed at a temperature of about 40° C. for about 1.5 hours.

In certain embodiments of the subject invention, an evaporative cooling composite is provided. The composite comprises a plurality of CaCl₂ nanoparticles; and a MOF-801 matrix. The composite is configured to adsorb atmospheric water or moisture at a first temperature and desorb the adsorbed atmospheric water or moisture at a second temperature, and wherein the first temperature is lower than the second temperature. Moreover, the MOF-801 matrix comprises a plurality of polycrystalline MOF-801 having a diameter of around 292 nm. The plurality of polycrystalline MOF-801 have a surface area of about 982.6 m² g⁻¹. The plurality of polycrystalline MOF-801 have an average pore size of about 1.75 nm. The CaCl₂ nanoparticles interconnect adjacent MOF-801 particles of the plurality of polycrystalline MOF-801. When the composite adsorbs water or moisture, grain boundaries of the plurality of polycrystalline MOF-801 inhibit CaCl₂ hydrate formed from becoming a solution. A ratio of mass of the MOF-801 matrix and volume of the CaCl₂ nanoparticles in the composite is configured such that CaCl₂@MOF-801 fully adsorbed with water or moisture is inhibited from becoming an aqueous solution. In addition, the CaCl₂ nanoparticles wrap around the plurality of polycrystalline MOF-801 and embed cages of the plurality of polycrystalline MOF-801. The composite can be produced by the method described above. Further, the composite is capable of adsorbing water or moisture up to about 22% of weight of the composite at relative humidity of 28% and up to about 80% of weight of the composite at relative humidity of 70%. Cooling power of the composite is in a range between 136 W/m² and 344 W/m². Atmospheric water adsorption capacity (AWAC) of the composite is up to about 0.80 g/g at relative humidity of 70% at a temperature of about 25° C. and AWAC of the composite is up to about 0.22 g/g at relative humidity of 28% at a temperature of about 25° C. at an adsorption time of about 1100 minutes as shown in FIG. 2H.

### BRIEF DESCRIPTION OF THE DRAWINGS

FIG. 1 is a schematic representation of the adsorption-desorption-evaporation process of the CaCl₂@MOF-801 based cooling coating, according to an embodiment of the subject invention.

FIGS. 2A-2H are schematic representations of the preparation process and the characterization of CaCl₂@MOF-801 composite, wherein FIG. 2A shows the preparation process of CaCl₂@MOF-801 based cooling coating, FIG. 2B shows the SEM images of MOF-801, FIGS. 2C and 2D show the CaCl₂@MOF-801 based coating, FIG. 2E shows the digital images of the CaCl₂@MOF-801 coating painted on a commercial PV panel via the blade coating method (inset), FIG. 2F shows the elemental mapping of C, Ca, Cl and O of the regions shown in FIG. 2D using energy dispersive spectroscopy, FIG. 2G shows the XRD patterns of MOF-801 and CaCl₂@MOF-801 after drying and adsorption, FIG. 2H shows the weight change of CaCl₂@MOF-801 based coating at a room temperature under different levels of relative humidity (RH) of 28%, 50%, 70% and 90%, according to an embodiment of the subject invention.

FIGS. 3A-3D show the cooling performance of the CaCl₂@MOF-801 based coating at RH of 28% and 70% when the ambient temperature is about 25° C., wherein FIG. 3A and FIG. 3B show the cooling performances of uncoated and coated photovoltaic (PV) panels with a coating thickness of 5 mm under solar irradiation of 1000 W/m² when the RH is 28% and 70%, respectively; and wherein FIG. 3C and FIG. 3D show the maximum cooling temperature of the coatings, cooling time, and weight change with various thicknesses under solar irradiation of 500 W/m², 1000 W/m², and 1300 W/m² when the RH is 28% and 70%, respectively, according to an embodiment of the subject invention.

FIGS. 4A-4E show the infrared (IR) images of the coated PV panels and the cooling performance of the composite coating, wherein FIG. 4A shows the time-dependent IR images of the uncoated and coated PV panels with various thicknesses under solar irradiation of 1000 W/m², FIG. 4B shows the “UST” pattern coated on the top of a PMMA substrate using both the commercial white putty powder and the CaCl₂@MOF-801 based coating, FIG. 4C shows the corresponding IR image of the “UST” pattern for FIG. 4B, FIG. 4D shows the weight change of the coatings under different solar irradiations for RH of 28% and RH of 70%, and FIG. 4E shows the calculated cooling power of the CaCl₂@MOF-801 coatings with various thicknesses under different solar irradiations, according to an embodiment of the subject invention.

FIGS. 5A-5L show the cooling performances of the coatings under three different workload conditions, the three workload conditions are (I) 3 hours pre-adsorption, solar irradiation for 20 minutes and switched off for 60 minutes; II) 12 hours pre-adsorption, solar irradiation for 20 minutes and switched off for 60 minutes; III) 12 hours pre-adsorption, solar irradiation for 40 minutes and switched off for 60 minutes, wherein in all the tests, the solar irradiation is 500 W/m², the temperature is about 25° C. and the RH is about 28% or about 70%, the temperature profiles of the uncoated (baseline) and coated PV panels under workload condition (I) shown in FIG. 5A, workload condition (II) shown in FIG. 5B, and workload condition (III) shown in FIG. 5C at RH@28%, and FIGS. 5D-5F the corresponding weight changes, the temperature profiles of the uncoated and coated PV panels under workload condition (I) shown in FIG. 5G, workload condition (II) shown in FIG. 5H, and workload condition (III) shown in FIG. 5I at RH@70%, and FIG. 5J-5L the corresponding weight changes, according to an embodiment of the subject invention.

FIGS. 6A-6D show the outdoor cooling performance of CaCl₂@MOF-801 based coating, wherein FIG. 6A shows a photography of the outdoor experiment setup on the rooftop of a building on the campus of HKUST, FIG. 6B shows the time-dependent temperatures of the uncoated and coated PV panels, FIG. 6C shows the ambient temperature and relative humidity acquired by the weather station, and FIG. 6D shows the corresponding weight change of the samples and the solar irradiation measured over the test day, according to an embodiment of the subject invention.

### DETAILED DISCLOSURE OF THE INVENTION

The embodiments of subject invention pertain to a composite of a sustainable evaporative cooling coating for a broad range of relative humidity and a method producing the composite.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

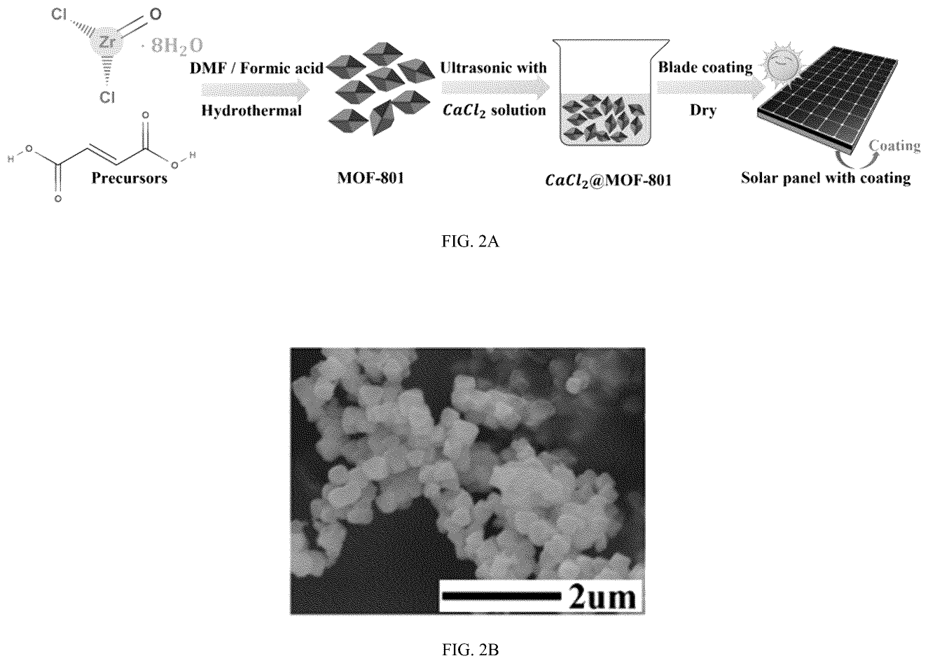

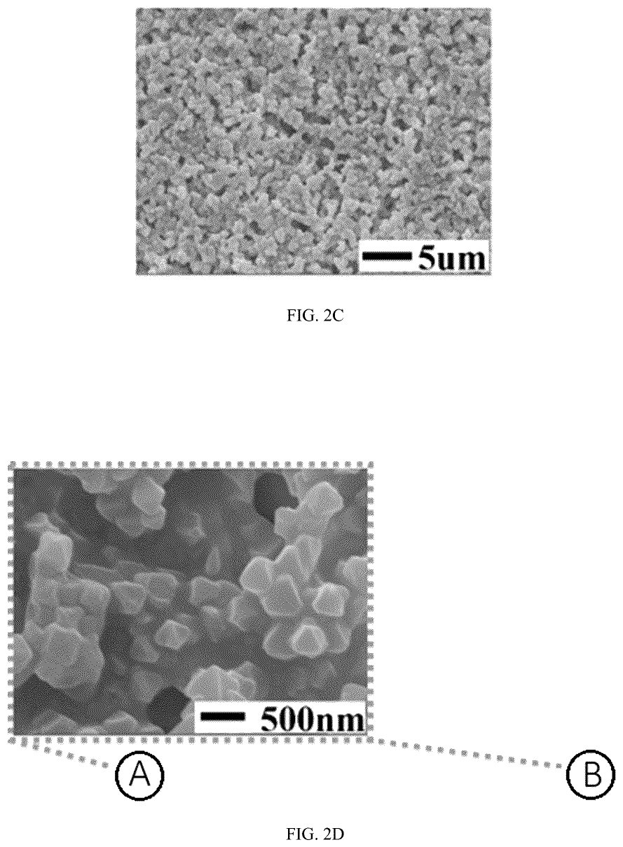

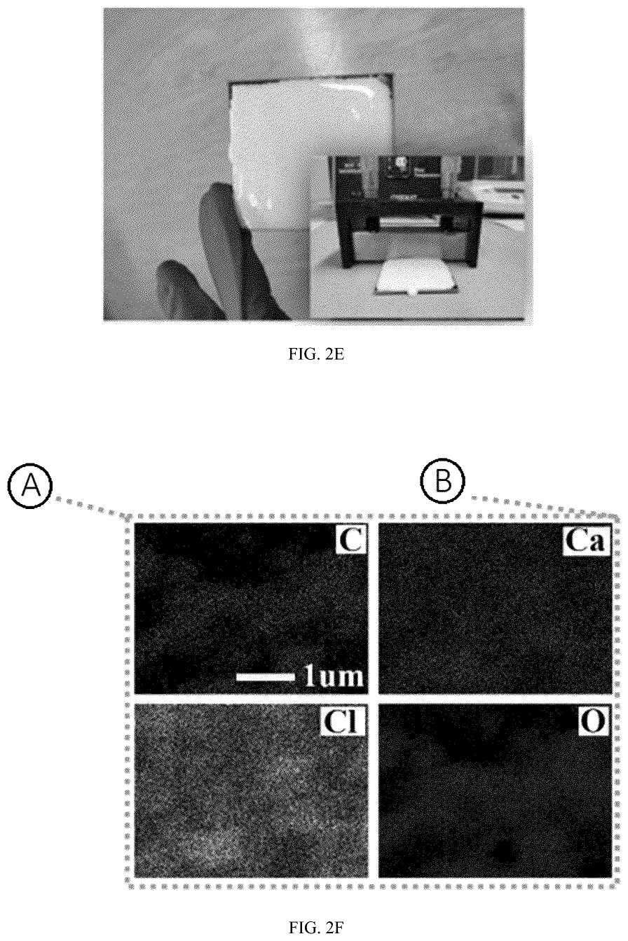

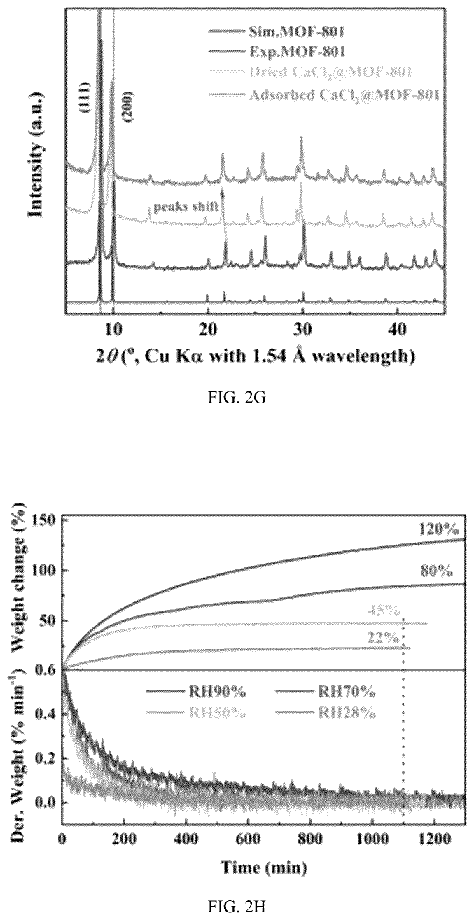

In embodiments of the subject invention, a CaCl₂@MOF-801 composite with excellent atmospheric water adsorption performance for a wide range of RH is provided. The as-synthesized composite can adsorb atmospheric water up to about 22% of its weight at the RH of 28% and about 80% of its weight at the RH of 70% at an adsorption time of about 1100 minutes as shown in FIG. 2H. It is demonstrated that the corresponding cooling power of the MOF-801 based composite ranges from 136 W/m² to 344 W/m² for a wide range of RH and solar intensities, resulting in passive evaporative cooling temperature up to 14° C. lower than that of the reference conventional technology in comparison.

The CaCl₂@MOF-801 composite provides the advantages of both MOF-801 and CaCl₂ of high-water adsorption capacity over a wide humidity range and turning to a solid form when it adsorbs water to a saturation level. For example, at a high RH of 70% and at a temperature of 25° C., atmospheric water adsorption capacity (AWAC) as high as about 0.80 g/g can be achieved thanks to the extremely high-atmospheric water adsorption ability of the CaCl₂ of the composite of the subject invention. In another example, at low RH of 28% and a temperature of 25° C., owing to the existence of MOF-801, the composite of the subject invention can achieve AWAC of about 0.22 g/g. Moreover, it is observed that the AWAC of the composite decreases with temperature. The desorption of the adsorbed water in the CaCl₂@MOF-801 composite can be achieved by raising temperature, for example, under sunlight. The desorption process takes away the heat and consequently cools down the target objects.

In one embodiment, the CaCl₂@MOF-801 based coating is applied onto photovoltaic (PV) panels to demonstrate its cooling performance. The results show that the temperature of the PV panel decreases by 9.5° C. at the RH of 28% and 14.1° C. at the RH of 70%, and the cooling time is about 134 minutes at the RH of 28% and more than 140 minutes at the RH of 70%, under one sun solar irradiation when the coating of 5 mm thickness is applied. At the RH of 28% and at 25° C., cooling power as high as 136 W/m² under one sun solar irradiation can be achieved by the coating of the subject invention. In addition, at the RH of 70% and at 25° C., cooling power as high as 315 W/m² under one sun solar irradiation can be achieved by the coating of the subject invention.

The recovery tests further show that the cooling performance of the cooling coating of the subject invention does not decay with time under certain working conditions.

### Materials and Methods

### Synthesis of MOF-801

To synthesize the MOF-801, 3.48 g (30 mmol) fumaric acid (obtained, for example, from Shanghai Macklin Biochemical Co., Ltd) and 9.66 g (30 mmol) ZrOCl₂·8H₂O (obtained, for example, from Aladdin Bio-Chem Technology, Shanghai) are dissolved in a solvent having 120 ml N, N-Dimethylformamide (obtained, for example, from DMF, RCI Labscan Limited) and 40 ml formic acid (obtained, for example, from AnalaR NORMAPUR® ACS, Reag. Ph. Eur.). The mixture is then put into a 500 ml beaker and stirred for about 1 hour at the room temperature to dissolve thoroughly. Next, the mixture is transferred to a 500 ml screw-capped jar and heated at 130° C. for 6 hours in the oven. The white precipitate of MOF-801 is obtained when the jar cools down to room temperature and the MOF-801 is separated by suction filtration using a Nylon membrane filter of a pore size of, for example, 0.45 μm (obtained, for example, from Jinteng, Tianjin), and washed with deionized (DI) water three times. The as-prepared MOF-801 solids are finally dried at 150° C. in a vacuum oven for 24 hours to activate the sample.

### Synthesis of CaCl₂@MOF-801 Composite

To synthesize the CaCl₂@MOF-801 composite of the subject invention, first, 8.88 g CaCl₂ (obtained, for example, from DIECKMANN, Shenzhen) solids are dissolved in 20 ml deionized (DI) water and ultrasonication is applied to the solution for 5 minutes. Then, a certain amount of the activated MOF-801 powder prepared as described above is mixed with the CaCl₂ solution under ultrasonication at a temperature of about 40° C. for about 1.5 hours to obtain a uniform mixture. An optimized ratio m_{MOF-801}:V_{CaCl}_{₂}=0.7 g/ml is chosen for all experiments, inhibiting the synthesized composite from being aqueous when its adsorbed water is saturated. The as-prepared composite is coated on the substrate by blade coater of which the thickness can be precisely controlled. Next, the coated sample is dried at 100° C. for about 1 hour to desorb the adsorbed water during the synthesis process.

### Characterization of Composite

The surface morphologies of the MOF-801 and the CaCl₂@MOF-801 composite are characterized by scanning electron microscopy (SEM) (for example, obtained from FEI QUANTA450 and JSM-7100F Jeol, respectively), and the EDS mapping is acquired by JSM-7100F Jeol. Energy-dispersive X-ray spectroscopy (EDS) is obtained via transmission electron microscopy (TEM (obtained, for example, from JEM-2010F, Jeol). The nitrogen gas adsorption of the activated MOF-801 is recorded by Brunauer-Emmett-Teller (Belsorp X mini) at 77 K with a pre-degassing temperature of 130° C. for 16 hours, during which the data collected is used for the analysis of the surface area and the pore size. Attenuated total reflectance Fourier-transform infrared spectroscopy (ATR-FTIR) (obtained, for example, from Vertex 70 Hyperion 1000 Bruker) is applied to obtain the spectrum information of MOF-801 powder. The Raman spectra are measured with a Raman spectroscope (obtained, for example, from RAMANMICRO 300, Perkin Elmer, USA, wavelength of laser=785 nm). Thermogravimetric analysis (TGA) measurement is performed on a TA instrument Q5000 series thermal gravimetric analyzer from 20° C. to 800° C. with a ramp rate of 5° C./min in N₂ atmosphere. The chemical composition and valance state of the MOF-801 are examined by X-ray photoelectron spectroscopy (XPS) (obtained, for example, from Axis Ultra DLD).

### Water Adsorption Capacity Measurement

The water adsorption properties of the CaCl₂@MOF-801 composite under different RH are measured in a control room and a man-made humidity controlling box. The experiments for the RH of 28% and 50% are conducted in the control room with a temperature of about 25° C., and the RH is controlled by a dry bulb temperature (DBT) and a wet bulb temperature (WBT) simultaneously. For example, the DBT and WBT are set as 25° C. and 17.91° C. It is noted that the WBT is 0.03° C. higher than the value calculated using the air enthalpy and the humidity diagram, which is caused by the error of the control room. The CaCl₂@MOF-801 composite is then coated on a glass plate, and located at a precision balance (for example, OHAUS, PR223ZH/E) connected to a computer by an RS232 communication cable, and the weight change is in-situ recorded. As for the experiments implemented under the RH of 70% and 90%, the precision balance is put into a man-made cabinet, and a humidifier is used to modulate the RH. The RH inside the box is monitored by a humidity sensor and controlled by a humidity controller with an accuracy of ±RH@3%.

Cooling Performance Tests under Laboratory Conditions

The CaCl₂@MOF-801 composite is first coated on the back of a commercial PV panel. The coated PV panels and the uncoated PV panels which are used for comparison are tested under various conditions. Before the test, the coated PV panels are heated at 100° C., followed by a 12-hour or 17-hour water adsorption process at the RH of 70% and at 25° C. The coated and uncoated PV panels are fixed on a foam holder of a same height. The systems are then placed on the precision balance. These samples are exposed to the solar simulator (for example, CHX-2000, obtained from Guangzhou Xingchuang electron Co., Ltd). The power density is adjusted via the solar controller. The solar irradiation is measured by a solar power meter (for example, ISM 410), whose spectral response is in a range of 400-1100 nm with an accuracy of 10 W/m².

The K-type thermal couples connected to a temperature meter are used to record the temperature of coated and uncoated PV panels during the tests. Furthermore, the temperatures and the RH of the ambient atmosphere are measured using a humidity and temperature sensor located about 75 cm away from the PV panels. The data obtained are recorded by a self-developed code based on LabVIEW 2019. The IR images of samples with different thicknesses and the “UST” pattern are captured by InfRec R550 PRO.

For outdoor measurements, the coated and uncoated PV panels are measured by a homemade apparatus on the roof of a building in the Hong Kong University of Science and Technology (HKUST, 22.3364.N, 114.2655.E) in September. The testing apparatus frame with a size of 14.5 cm×17 cm×7 cm (L×W×H) is made of foam and fixed on the balance. The experiments are conducted from 19:00 and last for a whole day. During the tests, the wind speed, solar irradiation intensities, environmental temperatures and the RH are recorded by a weather station, and the sensors are located near the samples. The temperature changes during the tests are obtained by the K-type thermal couples, and the weight changes of the coated PV panels are also recorded. Another temperature meter and humidity meter are also utilized to monitor the environment temperature and RH changes. The data are recorded by the LabVIEW program.

Following are examples that illustrate procedures for practicing the invention. These examples should not be construed as limiting. All percentages are by weight and all solvent mixture proportions are by volume unless otherwise noted.

### Example 1

### Design, Synthesis, and Characterization

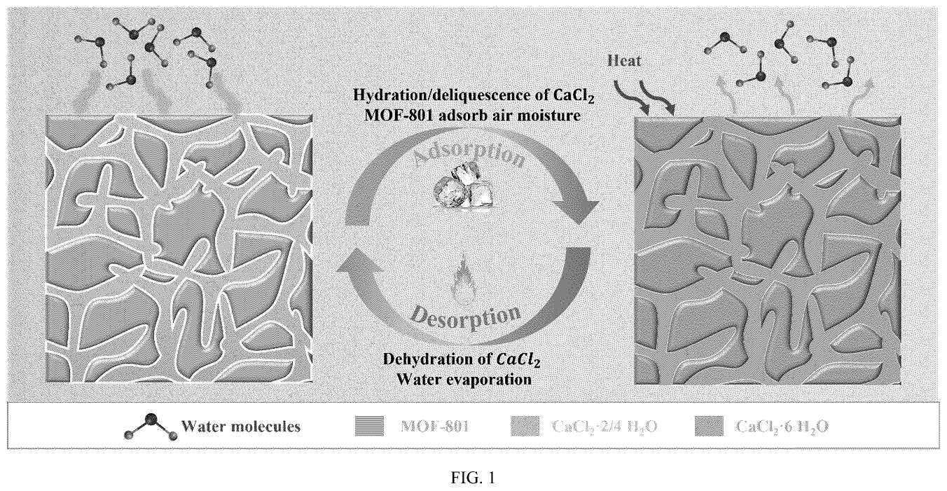

Although the AWAC of 20% of the MOF-801 measured at extremely low RH is excellent compared to conventional porous materials (37, 38), 1 g MOF-801 can only adsorb 0.38 g atmospheric water at RH of 90% and 25° C. As mentioned above, the performance of evaporative cooling coatings depends on their AWAC. Therefore, the MOF-801 is far from meeting the demand for high-power and long-time cooling. Therefore, a moisture hygroscopic salt of CaCl₂ having super high atmospheric water adsorption capacity at a wide RH range is composited in the MOF-801 matrix. The equilibrium water adsorption capacity of CaCl₂ at 25° C. exceeds 1 g/1 g, which is much larger than that of the conventional desiccants such as silica gel. By rationally controlling the ratio of MOF-801 in the composite, the fully adsorbed CaCl₂@MOF-801 can be avoided from becoming an aqueous solution. The synthesized CaCl₂@MOF-801 composite adsorbs atmospheric water at low temperatures, and the adsorbed atmospheric water is desorbed and evaporated at high temperatures. Herein, the CaCl₂@MOF-801 composite adsorbs the atmospheric water via three processes. The first process is the atmospheric water adsorption process of the MOF-801; in the second process, which is a chemical reaction process, the CaCl₂ is hydrated to form CaCl₂·6H₂O; and then in the third process, the CaCl₂·6H₂O is deliquescenced to eventually form aqueous solution. The CaCl₂@MOF-801 based coating composite that cools objects by the “breathing” process is shown in FIG. 1.

FIG. 2A shows the preparation process of the CaCl₂@MOF-801 based cooling coating. First, fumaric acid and ZrOCl₂·8H₂O are dissolved in a mixed solvent including N, N-Dimethylformamide and formic acid, followed by a chemical hydrothermal process. The polycrystalline MOF-801 is then separated from the mixture by suction filtration and dried in a vacuum oven. The diameter of the synthesized polycrystalline MOF-801 is determined to be around 292 nm as shown in FIG. 2B. The Brunauer-Emmett-Teller (BET) test results show that the surface area and pore size of the polycrystalline MOF-801 are about 982.6 m² g⁻¹ and about 1.75 nm, respectively. The characterization results obtained from Fourier-transform infrared spectroscopy (FTIR), Raman shift, thermal gravity analysis (TGA) and X-ray photoelectron spectroscopy (XPS) show good quality of polycrystalline MOF-801. The polycrystalline MOF-801 powder is next immersed into the CaCl₂ solution (for example, 4 mol/L) and mixed under ultrasonication for about 1.5 hours. As a result, the uniform CaCl₂@MOF-801 colloid is formed. The scanning electron microscopy (SEM) results demonstrate that the coating has high porosity with homogeneous pores at micrometers, and the particles are uniformly packed, which is beneficial for water storage during the water adsorption process, as shown in FIGS. 2C-2D. The CaCl₂@MOF-801 colloid can be coated on target objects via spin or blade coating as shown in FIG. 2E and the coating is shaped after drying. The distribution of C and O elements shown in the Energy Dispersive Spectroscopy (EDS) mapping of FIG. 2F indicates clear boundaries of the MOF-801 particles. While the Ca and Cl elements are distributed widely, the higher ratio observed in the connection areas between the MOF-801 particles indicates that the CaCl₂ components mainly exist in these areas and may be treated as a glue for the MOF-801 particles as shown in FIG. 2D. These grain boundaries of the MOF-801 particles can inhibit the CaCl₂ hydrate from forming a solution. Therefore, the fully adsorbed CaCl₂@MOF-801 does not become an aqueous solution. Meanwhile, the CaCl₂ nanoparticles can wrap the MOF-801 and embed the cages of the MOF-801, which are further proved by the XRD results. The good agreement of the peaks in the XRD spectra of MOF-801 between the experimental measurements and the simulation results indicates a high-quality crystallinity of MOF-801 as shown in FIG. 2G. The two large peaks below 10° are the (111) and (200) crystal orientations of the MOF-801. However, no apparent peaks for the CaCl₂ are observed in the saturated CaCl₂@MOF-801, which may be caused by the hydration of the hygroscopic salt. It is noted that all the peaks of MOF-801 have shifted to the left, suggesting an expansion of the MOF-801 due to the addition of the CaCl₂ nanoparticles. Moreover, FIGS. 2D and 2F show that the Cl and Ca elements exist everywhere, while the content ratio may be different as shown by the contrast, indicating that the CaCl₂ wraps around the MOF-801 particles. The XRD image of FIG. 2G shows that the CaCl₂ is inserted into the inner cages.

As discussed above, the atmospheric water adsorption ability of the CaCl₂@MOF-801 is the most critical factor for determining the cooling performance of the resultant coating. The AWAC of the CaCl₂@MOF-801 at various RH and at 25° C. are measured using a man-made humidity controlling box for the high RH (for example, 70% and 90%) or a control room for the low RH (for example, 28% and 50%). A balance with an accuracy of 1 mg is used to record the weight change of the CaCl₂@MOF-801 samples at different RH of 28%, 50%, 70%, and 90% as shown in FIG. 2H. The corresponding instantaneous adsorption speed calculated via the derivative of the weight change is also plotted in the bottom panel of FIG. 2H. At a low RH of 28%, the weight change or atmospheric water adsorption speed is large at the beginning and decreases to zero after around 600 minutes. The weight of the adsorbed atmospheric water after 1100 minutes is around 22% for the CaCl₂@MOF-801. At the RH of 50%, 70%, and 90%, the CaCl₂@MOF-801 coating shows a similar atmospheric water adsorption tendency except for the adsorption speed and AWAC. After 1100 minutes, the atmospheric water adsorption of CaCl₂@MOF-801 is about 45% of its weight at the RH of 50%. On the other hand, at the high RH of 70% and 90%, the CaCl₂@MOF-801 adsorbs atmospheric water about 80% and 120% of its weight after 1300 minutes. It is observed that the CaCl₂@MOF-801 composite adsorbs more atmospheric water at higher RH, since both CaCl₂ and MOF-801 have good atmospheric water adsorption capacity at high RH.

### Example 2

### Cooling Performance of the CaCl₂@MOF-801 Under Laboratory Conditions

The CaCl₂@MOF-801 based cooling coating is painted on the backside of commercial PV panels having a dimension of 5.5×5.5×0.24 cm³ via blade coating as shown in FIG. 2A. The coated PVs are then dried at 100° C. for 1 hour. It is noted that the thickness of the dried coating may decrease slightly. All the thicknesses mentioned thereafter refer to the initial thickness of the coating before drying. The thicknesses of the coatings vary from 3 to 5 mm with an interval of 1 mm. While it is possible to increase the thickness of the coating further, the cooling performance, such as the cooling time and cooling power, may not increase linearly due to the intrinsic high thermal resistance of the coating. All the samples are then tested by an experiment setup in a controlled room where the temperature and the RH can be precisely regulated. For all the tests, the temperature is set as 25° C., and RH is adjusted from 28% to 70%. The sample is first put in the controlled room for 12 hours to adsorb atmospheric water. The weight change of the coating and the environmental information are monitored by a precision balance and a thermo-hygrometer, respectively.

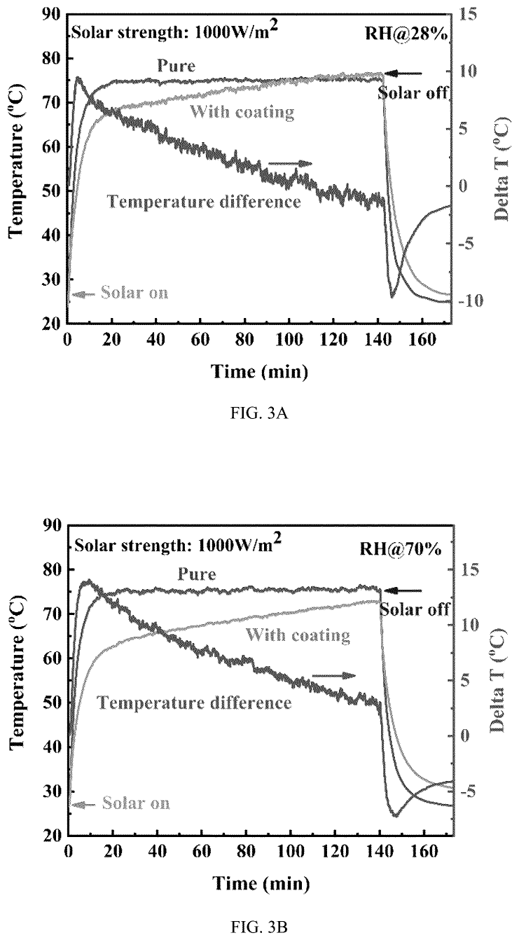

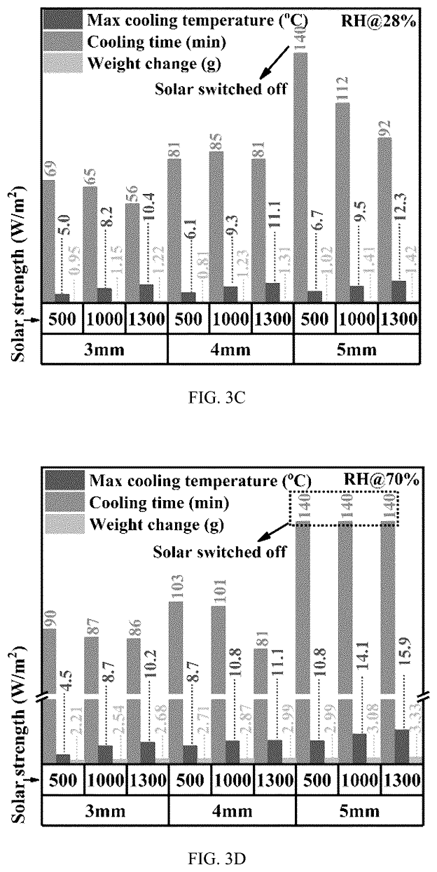

FIGS. 3A and 3B show the cooling performance of the sample with 5 mm coating under a 1000 W/m² solar irradiation provided by a solar simulator at RH of 28% and 70%. The test results demonstrate that the temperature of the uncoated PV panel increases quickly to a steady-state temperature of about 76° C. within about 20 minutes for the RH of 28% and 70% as shown in FIGS. 3A and 3B. In contrast, the temperature of the coated PV panel rose slowly to about 76° C. within about 112 minutes at RH of 28% as shown in FIG. 3A. When the RH is at 70%, the temperature of coated PV panel is lower than that of the uncoated sample during the whole irradiation period of 140 minutes as shown in FIG. 3B. The results demonstrate that the CaCl₂@MOF-801 based coating can decrease the temperature of the PV planes by as much as 9.5° C. for the RH of 28% and 14.1° C. for the RH of 70% as shown by the blue lines in FIGS. 3A and 3B. When most adsorbed atmospheric water is evaporated after a specific time, the temperature of the coated PV panel is found to be slightly higher than that of the uncoated PV panel, which is resulted from the low thermal conductivity of the CaCl₂@MOF-801 based coating. The solar simulator in the experiments is turned off at about 140 minutes for the samples with 5 mm thick coating (about 133 minutes for the samples with 3 mm and 4 mm thick coatings), and then the temperatures of the PV panels with/without the cooling coating drop suddenly to ambient temperature as shown in FIGS. 3A and 3B. When the thickness of the coating is decreased to 3 and 4 mm, the effective cooling time will then be reduced to about 65 and about 85 minutes for the RH of 28%; and to about 87) and about 101 minutes for the RH of 70%. The maximum cooling temperatures are about 8.2° C. and about 9.3° C. at the RH of 28% and about 8.7° C. and about 10.8° C. at RH of 70%, for the samples with 3 mm and 4 mm thick coatings, respectively.

The effects of the intensity of the solar irradiation on the cooling performance of the CaCl₂@MOF-801 composite coating with the solar irradiation of 500 and 1300 W/m² are further determined, and the results are plotted in FIG. 3C for the RH of 28% and FIG. 3D for the RH of 70%. The maximum cooling temperature of the coated samples increases with the increase of the solar irradiation intensity and the maximum cooling time of the coated samples decreases with the increase of the solar irradiation intensity, owing to the higher evaporative rate of water under stronger solar irradiation. Among all these samples, the CaCl₂@MOF-801 composite coating with a thickness of 5 mm achieves the highest maximum cooling temperatures of about 10.8° C. under the solar irradiation of 500 W/m² and about 15.9° C. under the solar irradiation of 1300 W/m², when the ambient RH and the temperature is 70% and 25° C., respectively. The corresponding cooling time under the solar irradiation of 1300 W/m² can be longer than 140 minutes.

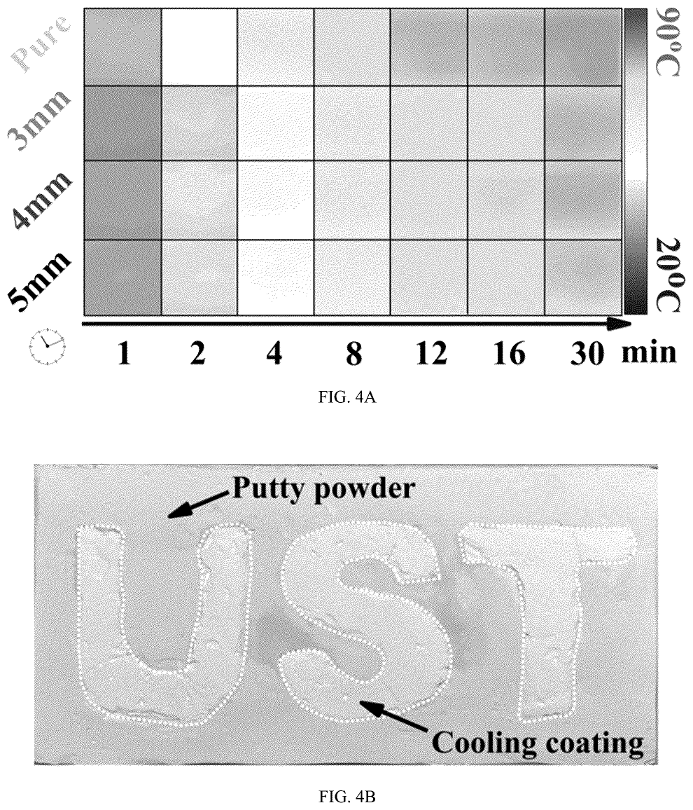

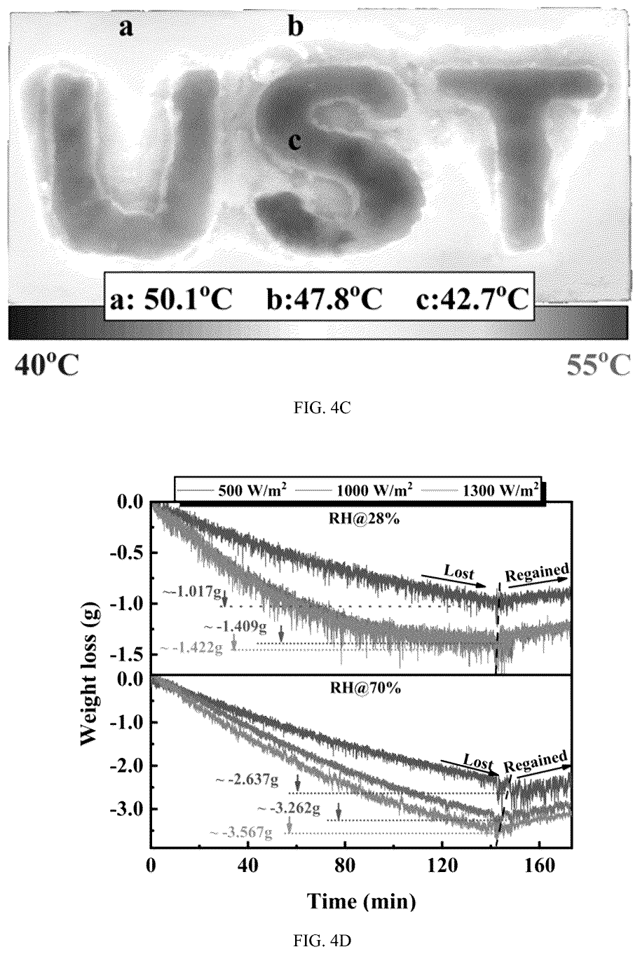

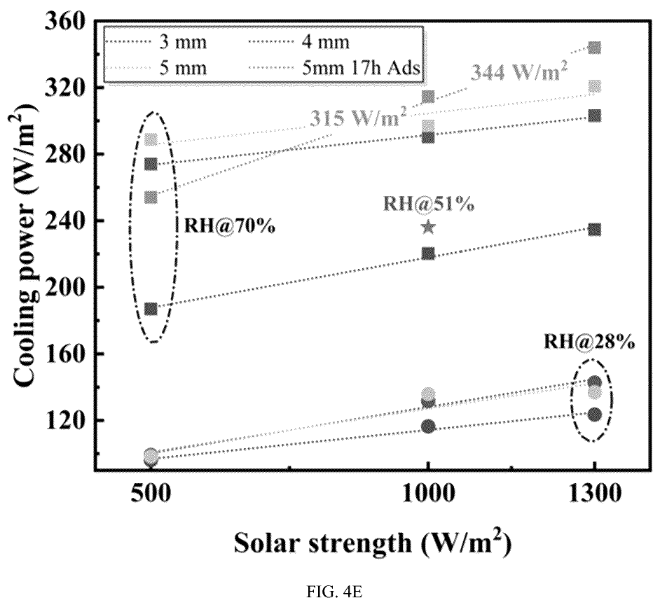

To further understand the cooling performance of the coatings, the spatial temperature distributions of the PV panels with/without cooling coatings are captured by an infrared (IR) camera as shown in FIG. 4A. All the samples are first put in the controlled room with RH of 28% and a temperature of 25° C. for 12 hours to adsorb atmospheric water. The PV panels with/without cooling coatings are then placed under one sun solar irradiation for 30 minutes. The PV panel without cooling coating is found to be heated up rapidly to about 75° C. In contrast, the temperature of the coated PV panel increases slowly due to the cooling effect of the coating of the subject invention, and the cooling coating having a thickness of 5 mm achieves the best cooling performance among all the samples, thanks to its greatest atmospheric water adsorption capacity as shown in FIG. 4A. The pattern “UST” is coated on top of a PMMA substrate using both the commercial white putty powder and CaCl₂@MOF-801 coating as shown in FIG. 4B, and it is then put in the indoor environment all night before the tests. The “UST” can be clearly distinguished by the IR camera when the corresponding sample is heated for several minutes as shown in FIG. 4C.

The weight changes of the coating having the thickness of 5 mm during the cooling tests under different solar irradiations are in-situ monitored to reveal the cooling process. As shown in the upper panel in FIG. 4D, after 12 hours of water adsorption at the RH of 28%, the evaporation rate of the adsorbed water, shown by the slope of the curves, decreases with time and is strongly dependent on the solar intensity. Higher solar intensity triggers faster water desorption that corresponds to larger water loss in the “water lost” region. It is determined that around 1.02 g, 1.41 g, and 1.42 g of water are evaporated during the “water lost” region when the solar irradiation is 500, 1000, and 1300 W/m², respectively. The water in the coating will continue to evaporate for a while due to the residual heat and then adsorb atmospheric water (“regained” region) again when the solar simulator is switched off at 140 minutes. Similar behaviors are observed for samples with 17 hours of water adsorption at RH of 70% as shown by the lower panel in FIG. 4D. However, the corresponding desorption rate becomes much larger due to the higher water uptake. A weight loss of 2.64 g, 3.26 g, and 3.57 g is achieved in the “water lost” region for a solar intensity of 500, 1000, and 1300 W/m², respectively. Correspondingly, the average evaporative cooling power Pₑ induced by the water evaporation is calculated by the equation: Pₑ=(Δm×hₑ)/(t×A) (24, 26), where Δm is the weight loss of water during the cooling period, t is the cooling time, h is the evaporation enthalpy of water, and A is the surface area (the side surfaces are ignored due to a much smaller size compared to the upper and lower surfaces) of the coating.

FIG. 4E shows plots of the average cooling power calculated from FIGS. 3C and 3D. It reveals that Pₑ is strongly related to the solar intensity and the coating thickness, and the highest cooling power about 136 W/m² under 1 sun can be achieved for the RH of 28% for the coating having a thickness of 5 mm, while the highest cooling power about 297 W/m² under 1 sun can be achieved for the RH of 70% for the coating having a thickness of 5 mm. To compare with previous work (24), the PV panel is coated a coating having a thickness of 5 mm in the controlled room having a temperature of 25° C. and RH of 70% to adsorb the atmospheric water for 17 hours. The cooling power can be further increased to 315 (344) W/m² when the solar irradiation is 1000 (1300) W/m², which is comparable to the results of Li et. al. (24) and Wang et. al. (25). The system of Li et. al. (24) cooled the PV panels using a 0.5 cm PAM-CNT-CaCl₂ coating at 22° C. and RH at 60% and an average cooling power of 295 W/m² under 1 sun was obtained. The system of Wang et. al. (25) cooled the electronics using the MIL-101 (Cr) based coating with a thickness of 516 μm at 25° C. and RH of 60%, and a cooling power of about 281 W/m² is achieved. The experiments of subject invention conducted at RH of 51% under 1 sun irradiation show that the corresponding cooling power is 236 W/m². The passive evaporative cooling power here is comparable to or better than the cooling limit of the conventional technologies such as radiative cooling (45).

### Example 3

### Recovery Tests of CaCl₂@MOF-801 Based Cooling Coating

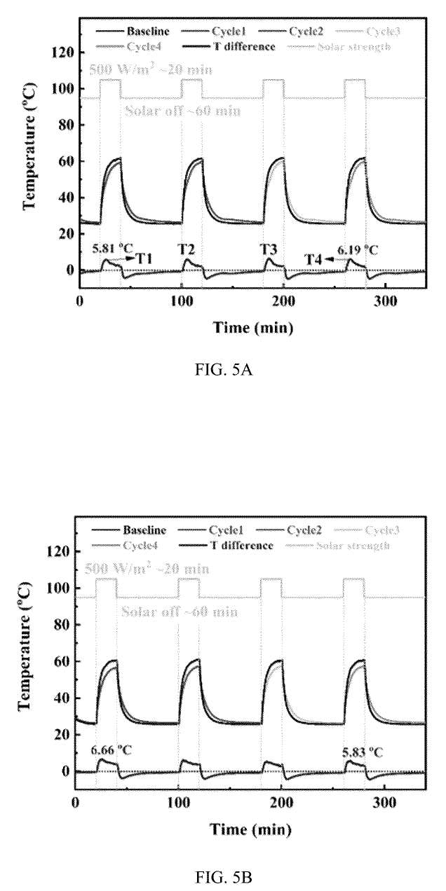

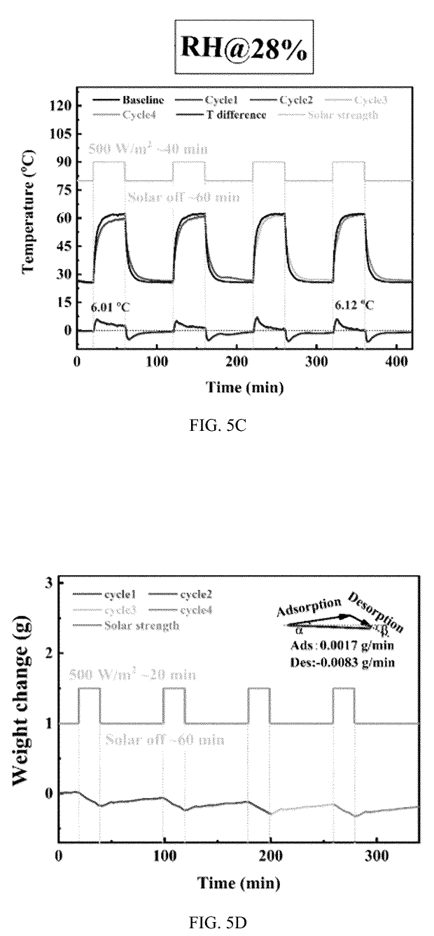

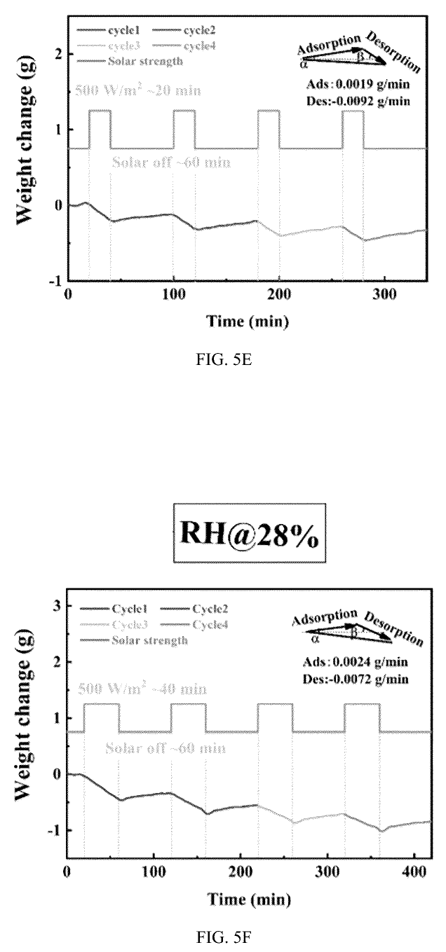

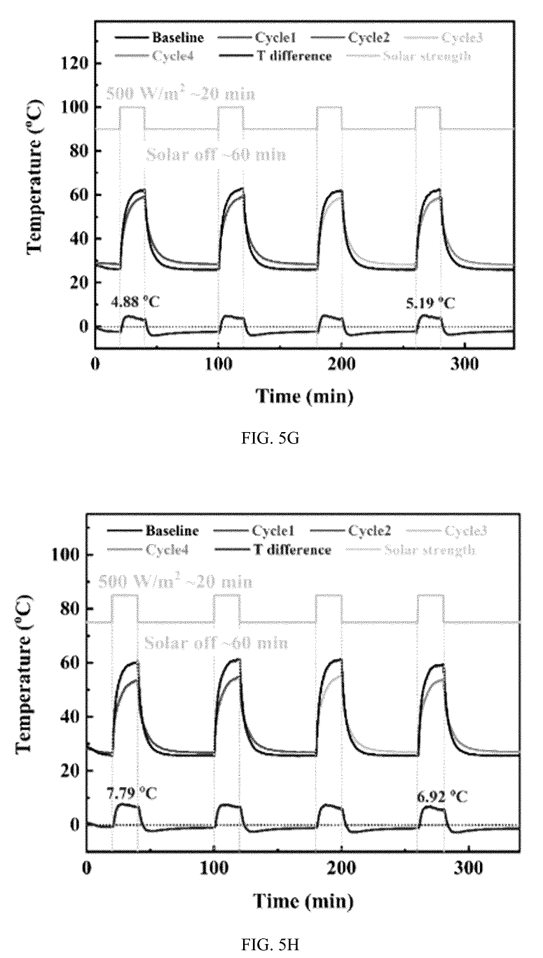

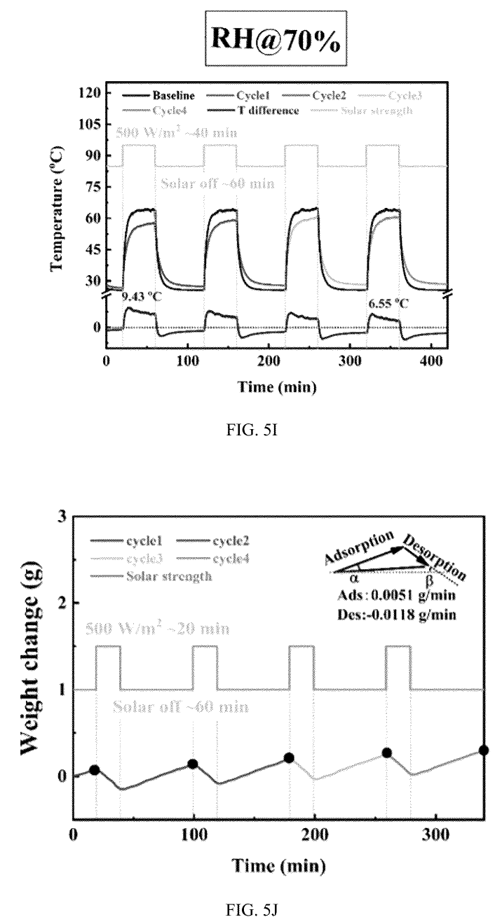

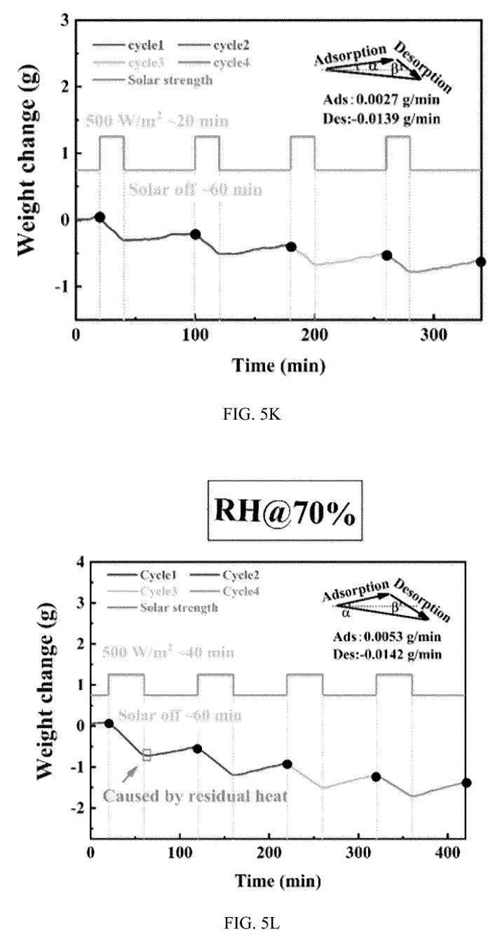

At the same time, the passive recovery capacity owing to the spontaneous adsorption process of the cooling coating is another critical point for practical applications, which determines whether the cooling coating can work continuously and naturally. Herein, the PV panel with a coating having a thickness of 5 mm is subjected to three different intermittent working conditions with solar irradiations of 500, 1000, and 1300 W/m² to demonstrate its recovery capacity. All the experiments are carried out in the controlled room of 25° C. and RH of about 28% or about 70%. The real-time temperature and weight change of the coating during four successive cycles are recorded and shown in FIGS. 5A-5L. Three periodic workloads are set as follows: I) 3 hours of pre-adsorption, solar irradiation for 20 minutes and off for 60 minutes, II) 12 hours of pre-adsorption, solar irradiation for 20 minutes and off for 60 minutes, III) 12 hours of pre-adsorption, solar irradiation for 40 minutes and off for 60 minutes. All the results plotted in FIGS. 5A-5L are obtained under the solar irradiation of 500 W/m².

FIGS. 5A-5C show that the temperature profile in each cycle is similar when the solar irradiation is 500 W/m² at the RH of 28%. Under the workload condition I, a maximum cooling temperature of 5.81° C. (referred to as T₁) is achieved in the first cycle, and it slightly increases in the later cycles, attaining 6.19° C. (referred to as T₄) in the final cycle as shown in FIG. 5A. The increase in the maximum cooling temperature is attributed to the rapid spontaneous water adsorption of the coating when the solar simulator is turned off. The maximum cooling temperature for the workload condition II decreases from 6.66° C. for the first cycle to 5.83° C. for the last cycle as shown in FIG. 5B, the maximum cooling temperature for the workload condition III increases from 6.01° C. for the first cycle to 6.12° C. for the last cycle as shown in FIG. 5C.

When the RH is 70%, similar results are obtained and shown in FIGS. 5G-5I. The maximum cooling temperature slightly increases from 4.88° C. to 5.19° C. for workload condition I, decreases from 7.79° C. to 6.92° C. for workload condition II, and decreases from 9.43° C. to 6.55° C. for the workload condition III.

These findings can be explained by the weight change of the adsorbed atmospheric water during the cycles as shown in FIGS. 5D-5F and FIGS. 5J-5I. The weight change of the coating in both “solar on” and “solar off” periods can be approximately treated as linear. The adsorption speed α and desorption speed β are defined as the slopes of coatings' weight change for the “solar on” and “solar off” periods, respectively. The “solar on” region of the third cycle and “solar off” region of the second cycle are chosen to fit α and β linearly. For the workload condition I, the coating weight at the finish point of each adsorption cycle increases with the cycle as shown by the black points in FIG. 5J. As a result, the adsorbed atmospheric water in the coating of the subject invention at the beginning point of each desorption cycle increases, and thereby the maximum cooling temperature increases. A degradation number D=(tₐα)/(t_{d}β) is then defined to describe the recovery capacity also the degradation degree of cooling performance, where tₐ and t_{d} are the adsorption and the desorption time, respectively. When D>1, more water is adsorbed during the cycling test because the adsorbed water cannot be fully desorbed during the “solar on” period, and thereby the cooling performance is continuously enhanced as shown in FIG. 5J. On the other hand, D=1 indicates that the adsorbed water is equal to the desorbed water, and the maximum cooling temperature is almost a constant after multiple cycles, and the cooling performance can fully recover. However, the degradation of cooling performance occurs when D=1, showing a decrease in the water content that results in a decreasing maximum cooling temperature as shown in FIGS. 5E, 5F, 5K and 5L. For higher solar irradiation under 1000 and 1300 W/m², the weight is always found to decrease. Therefore, it is crucial to choose suitable workload conditions to achieve a stable and sustainable cooling performance. Herein, the difference ΔT=T₄−T₁ is configured to find out the best solar irradiation at a specific workload because ΔT should have a positive correlation with D For the workload condition I at RH@28%, ΔT=0 when the solar irradiation intensity is about 590 W/m². Consequently, under workload condition I, the coating can have a stable cooling performance without degradation when the solar irradiation is smaller than 590 W/m². The critical solar irradiation intensity under the workload condition I at the RH of 70% is around 805 W/m². For the other workload conditions, the critical solar irradiation intensity to ensure a stable cooling performance of the coating does not exist, which may be avoided by applying the coating under weaker solar irradiation or prolonging the water adsorption time of the coating within the cooling cycles.

### Example 4

### Field Tests of Cooling Performance

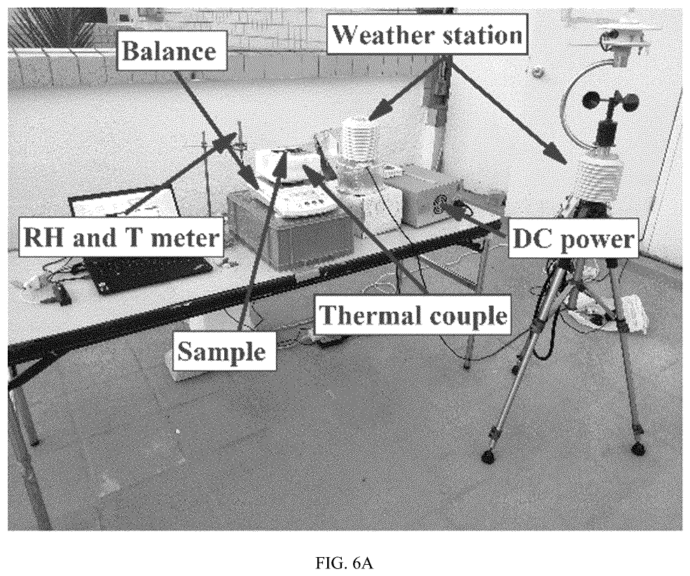

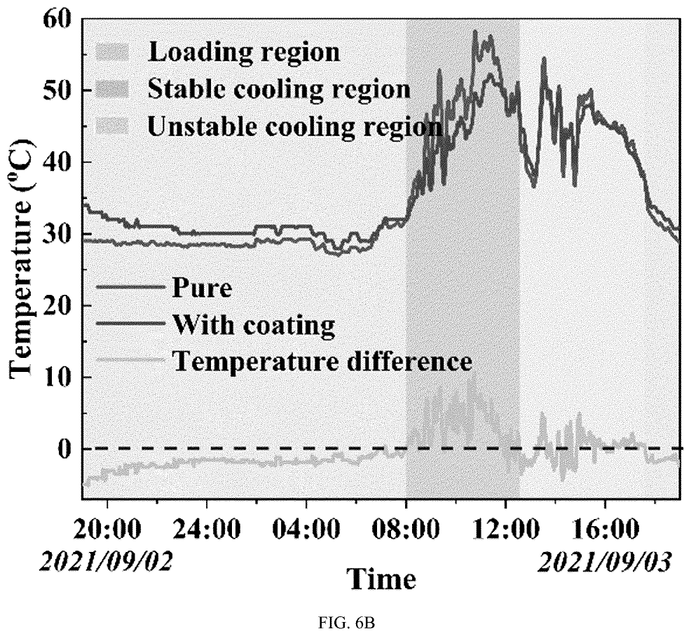

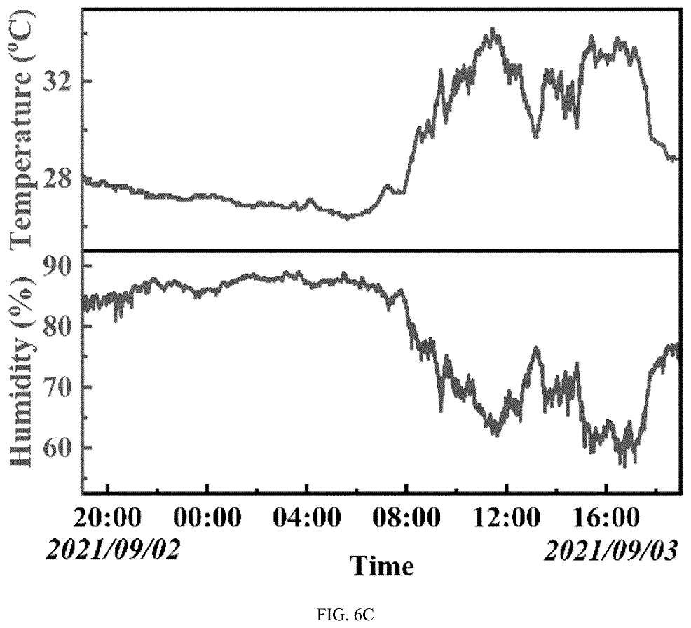

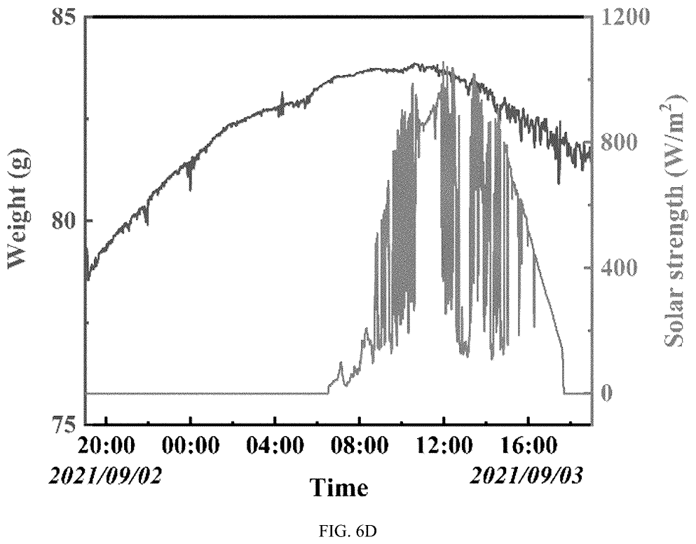

To further investigate the practicability of the CaCl₂@MOF-801 based coating of the subject invention, the cooling tests are conducted under real outdoor conditions. The tests are performed on a rooftop of an academic building in Hong Kong University and Science and Technology (HKUST) (22.3364.N, 114.2655.E). The wind speed, solar irradiation intensity, ambient temperature, and RH are monitored by a commercial weather station in real-time. The weight change of the coating and the temperature of the PV panel are recorded by a precision balance and thermal couples as shown in FIG. 6A, respectively.

The PV panels with/without cooling coatings are exposed to air at 19:00 on Sep. 2, 2021 right after sunset, and the test lasts for one day until 19:00 on Sep. 3, 2021 and results are shown in FIG. 6B. The average RH and temperature during the night when atmospheric water adsorption happened are around 88% and 27° C. as shown in in FIG. 6C, respectively. During the daytime, the RH decreases to about 66%, and the temperature slightly increases to 30° C. In this period, the adsorbed water begins to evaporate as the solar irradiation intensity becomes higher. FIG. 6D shows that the coating adsorbs atmospheric water from 19:00 to around 8:00 on the next day (referred to as the loading region in FIG. 6B), and the temperature of the coated PV panel is slightly higher than that of the uncoated PV panel owing to the exothermic phenomena during the adsorption process. When the solar irradiation starts to increase after 8:00, the coated PV panel shows a temperature lower than the uncoated sample due to the cooling effect of the coating. The maximum cooling temperature of about 10° C. is achieved at about 11:00 when solar irradiation is around 900 W/m². Overall, the temperature of the coated PV panel is lower than that of the uncoated PV panel from 8:00 to 12:30, suggesting a 4.5-hour stable cooling period as shown in FIG. 6B. From 12:30 to 17:30, the temperature difference between the coated and the uncoated PV panels fluctuates around zero as shown in FIG. 6D. After the sunset at around 17:30, the temperature of the coated PV panel starts to be slightly higher than that of the uncoated PV panel. It is noted that the final weight of the coating is larger than its original weight, indicating that the cooling coating has a no-degrading cooling performance with time. The findings demonstrate the feasibility and versatility of application of the CaCl₂@MOF-801 coating for comprehensive cooling operations.

The coating of the subject invention has excellent atmospheric water absorption performance in a wide range of RH through compositing hygroscopic salt CaCl₂ nanoparticles into the MOF-801 matrix. The synthesized CaCl₂@MOF-801 composite adsorbs atmospheric water up to about 22% of its weight at the RH of 28% due to the MOF-801 and has a superhigh atmospheric water adsorption ability at high RH due to the CaCl₂ (for example, the adsorbed atmospheric water is about 80% of the weight of the composite at the RH of 70%). The corresponding “breathing”-like atmospheric water adsorption and desorption process enables the CaCl₂@MOF-801 based coating to cool the objects naturally and sustainably. By applying CaCl₂@MOF-801 based coating having a thickness of 5 mm on the commercial PV panel in an environment at the RH of 28% and at the temperature of 25° C., the temperature of the coated PV panel can be decreased as much as 9.5° C. compared to that of the uncoated PV panel under one sun solar irradiation and the effective cooling time is 112 minutes; and in an environment at the RH of 70% and at the temperature of 25° C., the temperature of the coated PV panel can be decreased as much as 14° C. compared to that of the uncoated PV panel under one sun solar irradiation and the effective cooling time is more than 140 minutes.

Further, the resulting cooling power is 136 W/m² for the RH of 28% and 315 W/m² for the RH of 70%. The recovery capacity of the CaCl₂@MOF-801 based cooling coating is determined and it is found that the cooling performance does not degrade under specific workload conditions. Moreover, the field test shows that the coating can cool the PV panel for 4.5 hours with a maximum cooling temperature of about 10° C. in the natural environment.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

1. A. Deroubaix, I. Labuhn, M. Camredon, B. Gaubert, P. A. Monerie, M. Popp, J. Ramarohetra, Y. Ruprich-Robert, L. G. Silvers, G. Siour, Large uncertainties in trends of energy demand for heating and cooling under climate change. Nat. Commun. 12, 5197 (2021).
2. H. Wang, Q. Chen, Impact of climate change heating and cooling energy use in buildings in the United States. Energy Build. 82, 428-436 (2014).
3. G. I. Meijer, Engineering. Cooling energy-hungry data centers. Science 328, 318-319 (2010).
4. H. Zhang, S. Shao, H. Xu, H. Zou, C. Tian, Free cooling of data centers: A review. Renew. Sustain. Energy Rev. 35, 171-182 (2014).
5. D. Bredemeier, D. Walter, S. Herlufsen, J. Schmidt, Lifetime degradation and regeneration in multicrystalline silicon under illumination at elevated temperature. AIP Adv. 6, (2016).
6. E. Skoplaki, J. A. Palyvos, On the temperature dependence of photovoltaic module electrical performance: A review of efficiency/power correlations. Sol. Energy 83, 614-624 (2009).
7. L. W. Davis, P. J. Gertler, Contribution of air conditioning adoption to future energy use under global warming. Proc. Natl. Acad. Sci. U.S.A 112, 5962-5967 (2015).
8. R. van Erp, R. Soleimanzadeh, L. Nela, G. Kampitsis, E. Matioli, Co-designing electronics with microfluidics for more sustainable cooling. Nature 585, 211-216 (2020).
9. U.S. Department of Energy, Heating and Cooling; https://www.energy.gov/energysaver/heating-and-cooling.
10. A. Shehabi, S. Smith, D. Sartor, R. Brown, M. Herrlin, J. Koomey, E. Masanet, N. Horner, I. Azevedo, W. Lintner, “United states data center energy usage report” (Lawrence Berkeley National Laboratory, Berkeley, California. LBNL-1005775, 2016).
11. Census and statistic Department, the government of the Hongkong special administrative, region-electricity consumption (2020); https://www.censtatd.gov.hk/en/web_table.html?id=127.
12. S. Catalanotti, V. Cuomo, G. Piro, D. Ruggi, V. Silvestrini, G. Troise, The radiative cooling of selective surfaces. Sol. Energy 17, 83-89 (1975).
13. M. Isaac, D. P. van Vuuren, Modeling global residential sector energy demand for heating and air conditioning in the context of climate change. Energy Policy 37, 507-521 (2009).
14. M. Jakubcionis, J. Carlsson, Estimation of European Union service sector space cooling potential. Energy Policy 113, 223-231 (2018).
15. H. Thomson, N. Simcock, S. Bouzarovski, S. Petrova, Energy poverty and indoor cooling: An overlooked issue in Europe. Energy Build. 196, 21-29 (2019).
16. A. A. Lindley, A. McCulloch, Regulating to reduce emissions of fluorinated greenhouse gases. J. Fluorine Chem. 126, 1457-1462 (2005).
17. H. L. van Soest, M. G. J. den Elzen, D. P. van Vuuren, Net-zero emission targets for major emitting countries consistent with the Paris Agreement. Nat. Commun. 12, 2140 (2021).
18. B. Soergel, E. Kriegler, I. Weindl, S. Rauner, A. Dirnaichner, C. Ruhe, M. Hofmann, N. Bauer, C. Bertram, B. L. Bodirsky, M. Leimbach, J. Leininger, A. Levesque, G. Luderer, M. Pehl, C. Wingens, L. Baumstark, F. Beier, J. P. Dietrich, F. Humpenöder, P. von Jeetze, D. Klein, J. Koch, R. Pietzcker, J. Strefler, H. Lotze-Campen, A. Popp, A sustainable development pathway for climate action within the UN 2030 Agenda. Nat. Clim. Change 11, 656-664 (2021).
19. L. Zhang, Y. Feng, Q. Meng, Y. Zhang, Experimental study on the building evaporative cooling by using the Climatic Wind Tunnel. Energy Build. 104, 360-368 (2015).
20. Y. Zhang, L. Zhang, Z. Pan, Q. Meng, Y. Feng, Y. Chen, Hydrological properties and solar evaporative cooling performance of porous clay tiles. Constr Build Mater. 151, 9-17 (2017).
21. M. Hendel, M. Colombert, Y. Diab, L. Royon, An analysis of pavement heat flux to optimize the water efficiency of a pavement-watering method. Appl. Therm. Eng. 78, 658-669 (2015).
22. H. Li, J. T. Harvey, T. Holland, M. Kayhanian, The use of reflective and permeable pavements as a potential practice for heat island mitigation and stormwater management. Environ. Res. Lett. 8, 015023 (2013).
23. M. Jiang, Y. Wang, F. Liu, H. Du, Y. Li, H. Zhang, S. To, S. Wang, C. Pan, J. Yu, D. Quere, Z. Wang, Inhibiting the Leidenfrost effect above 1,000 degrees C. for sustained thermal cooling. Nature 601, 568-572 (2022).
24. R. Li, Y. Shi, M. Wu, S. Hong, P. Wang, Photovoltaic panel cooling by atmospheric water sorption-evaporation cycle. Nat. Sustain. 3, 636-643 (2020).
25. C. Wang, L. Hua, H. Yan, B. Li, Y. Tu, R. Wang, A Thermal Management Strategy for Electronic Devices Based on Moisture Sorption-Desorption Processes. Joule 4, 435-447 (2020).
26. A. Aili, X. Yin, R. Yang, Passive sub-ambient cooling: radiative cooling versus evaporative cooling. Appl. Therm. Eng. 202, (2022).
27. S. H. Schneider, Encyclopedia of climate and weather (Oxford University Press, 2011), vol. 1.
28. J. Xu, T. Li, J. Chao, S. Wu, T. Yan, W. Li, B. Cao, R. Wang, Efficient Solar-Driven Water Harvesting from Arid Air with Metal-Organic Frameworks Modified by Hygroscopic Salt. Angew. Chem. Int. Ed. 59, 5202-5210 (2020).
29. A. Rezk, R. Al-Dadah, S. Mahmoud, A. Elsayed, Characterisation of metal organic frameworks for adsorption cooling. Int. J. Heat Mass Transf. 55, 7366-7374 (2012).
30. H. Kim, S. Yang, S. R. Rao, S. Narayanan, E. A. Kapustin, H. Furukawa, A. S. Umans, O. M. Yaghi, E. N. Wang, Water harvesting from air with metal-organic frameworks powered by natural sunlight. Science 356, 430-432 (2017).
31. F. Fathieh, M. J. Kalmutzki, E. A. Kapustin, P. J. Waller, J. Yang, O. M. Yaghi, Practical water production from desert air. Sci. Adv. 4, eaat3198 (2018).
32. X. Wang, X. Li, G. Liu, J. Li, X. Hu, N. Xu, W. Zhao, B. Zhu, J. Zhu, An Interfacial Solar Heating Assisted Liquid Sorbent Atmospheric Water Generator. Angew. Chem. Int. Ed. 58, 12054-12058 (2019).
33. S. Bouzenada, A. N. Kaabi, L. Frainkin, T. Salmon, A. Ldonard, Experimental Comparative Study on Lithium Chloride and Calcium Chloride Desiccants. Procedia Comput. Sci. 83, 718-725 (2016).
34. R. Li, Y. Shi, M. Alsaedi, M. Wu, L. Shi, P. Wang, Hybrid Hydrogel with High Water Vapor Harvesting Capacity for Deployable Solar-Driven Atmospheric Water Generator. Environ. Sci. Technol. 52, 11367-11377 (2018).
35. L. J. Mauer, L. S. Taylor, Water-solids interactions: deliquescence. Annu. Rev. Food Sci. Technol. 1, 41-63 (2010).
36. F. E. M. O'Brien, The Control of Humidity by Saturated Salt Solutions. J. Sci. Instrum. 25, 73-76 (1948).
37. J. Canivet, A. Fateeva, Y. Guo, B. Coasne, D. Farrusseng, Water adsorption in MOFs: fundamentals and applications. Chem. Soc. Rev. 43, 5594-5617 (2014).
38. N. C. Burtch, H. Jasuja, K. S. Walton, Water stability and adsorption in metal-organic frameworks. Chem. Rev. 114, 10575-10612 (2014).
39. H. Zhang, Y. Yuan, Q. Sun, X. Cao, L. Sun, Steady-state equation of water vapor sorption for CaCl₂)-based chemical sorbents and its application. Sci. Rep. 6, 34115 (2016).
40. P. A. Kallenberger, M. Froba, Water harvesting from air with a hygroscopic salt in a hydrogel-derived matrix. Commun. Chem. 1, 28 (2018).
41. H. U. Rammelberg, T. Schmidt, W. Ruck, Hydration and dehydration of salt hydrates and hydroxides for thermal energy storage—kinetics and energy release. Energy Procedia 30, 362-369 (2012).
42. M. Baumgartner, R. J. Bakker, CaCl₂)-hydrate nucleation in synthetic fluid inclusions. Chem. Geol. 265, 335-344 (2009).
43. K. Fujioka, H. Suzuki, Thermophysical properties and reaction rate of composite reactant of calcium chloride and expanded graphite. Appl. Therm. Eng. 50, 1627-1632 (2013).
44. K. E. N′Tsoukpoe, H. U. Rammelberg, A. F. Lele, K. Korhammer, B. A. Watts, T. Schmidt, W. K. L. Ruck, A review on the use of calcium chloride in applied thermal engineering. Appl. Therm. Eng. 75, 513-531 (2015).
45. S. Buddhiraju, P. Santhanam, S. Fan, Thermodynamic limits of energy harvesting from outgoing thermal radiation. Proc. Natl. Acad. Sci. U.S.A 115, E3609-E3615 (2018).

We claim:

1. A method of producing an evaporative cooling composite, the method comprising:
obtaining MOF-801; and
preparing CaCl₂@MOF-801 composite based on the MOF-801;
wherein the obtaining MOF-801 comprises:
dissolving a predetermined amount of fumaric acid and a predetermined amount of ZrOCl₂·8H₂O into a solvent having a predetermined amount of N, N-Dimethylformamide and a predetermined amount of formic acid to produce a mixture;
heating the mixture at a predetermined temperature for a predetermined amount of time;
cooling the mixture to room temperature to obtain precipitate of MOF-801;
separating the MOF-801 by a filter of a predetermined pore size; and
drying the separated MOF-801 at a predetermined temperature for a predetermined amount of time to activate the MOF-801; and
wherein the preparing CaCl₂@MOF-801 composite comprises:
dissolving a predetermined amount of CaCl₂ in deionized (DI) water;
applying ultrasonication to the solution for a predetermined amount of time; and
mixing the MOF-801 with the CaCl₂ solution under ultrasonication at a predetermined temperature for a predetermined amount of time.

2. The method of claim 1, wherein the CaCl₂@MOF-801 composite is configured to have a ratio of m_{MOF-801}:V_{CaCl}_{₂}=0.7 g/ml such that the CaCl₂@MOF-801 composite is inhibited from being aqueous when water or moisture adsorbed by the CaCl₂@MOF-801 composite is saturated.

3. The method of claim 1, wherein the fumaric acid and the ZrOCl₂·8H₂O have an equal mole amount.

4. The method of claim 1, wherein the heating the mixture is performed at a temperature of about 130° C. for about 6 hours.

5. The method of claim 1, wherein the filter has a pore size of about 0.45 μm.

6. The method of claim 1, wherein the drying the separated MOF-801 is performed at a temperature of about 150° C. in a vacuum condition for about 24 hours.

7. The method of claim 1, wherein the mixing the MOF-801 with the CaCl₂ solution under ultrasonication is performed at a temperature of about 40° C. for about 1.5 hours.

8. An evaporative cooling composite, comprising:
a plurality of CaCl₂ nanoparticles; and
a MOF-801 matrix.

9. The composite of claim 8, wherein the composite is configured to adsorb atmospheric water or moisture at a first temperature and desorb the adsorbed atmospheric water or moisture at a second temperature, and wherein the first temperature is lower than the second temperature.

10. The composite of claim 8, wherein the MOF-801 matrix comprises a plurality of polycrystalline MOF-801 having a diameter of around 292 nm.

11. The composite of claim 8, wherein the plurality of polycrystalline MOF-801 have a surface area of about 982.6 m² g⁻¹.

12. The composite of claim 8, wherein the plurality of polycrystalline MOF-801 have an average pore size of about 1.75 nm.

13. The composite of claim 8, wherein the CaCl₂ nanoparticles interconnect adjacent MOF-801 particles of the plurality of polycrystalline MOF-801.

14. The composite of claim 8, wherein when the composite adsorbs water or moisture, grain boundaries of the plurality of polycrystalline MOF-801 inhibit CaCl₂ hydrate formed from becoming a solution.

15. The composite of claim 8, wherein a ratio of mass of the MOF-801 matrix and volume of the CaCl₂ nanoparticles in the composite is configured such that CaCl₂@MOF-801 fully adsorbed with water or moisture is inhibited from becoming an aqueous solution.

16. The composite of claim 8, wherein the CaCl₂ nanoparticles wrap around the plurality of polycrystalline MOF-801 and are embedded into cages of the plurality of polycrystalline MOF-801.

17. The composite of claim 8, wherein the composite is capable of adsorbing water or moisture up to about 22% of weight of the composite at relative humidity of 28% and up to about 80% of weight of the composite at relative humidity of 70% at an adsorption time of about 1100 minutes.

18. The composite of claim 8, wherein cooling power of the composite is in a range between 136 W/m² and 344 W/m².

19. The composite of claim 8, wherein atmospheric water adsorption capacity (AWAC) of the composite is up to about 0.80 g/g at relative humidity of 70% at a temperature of about 25° C. and AWAC of the composite is up to about 0.22 g/g at relative humidity of 28% at a temperature of about 25° C.

20. The evaporative cooling composite, comprising:
a plurality of CaCl₂) nanoparticles;
a MOF-801 matrix; and
wherein the composite is produced by the method of claim 1.
